(19) United States
(12) Patent Application Publication
(10) Pub. No.: US 2010/0313175 A1
(43) Pub. Date: Dec. 9, 2010

(54) VERIFICATION SYSTEMS AND METHODS

(75) Inventor: Oleg Alexandrovich Petlin, Ashland, MA (US)

Correspondence Address: GUERIN & RODRIGUEZ, LLP, 5 MT. ROYAL AVENUE, MARLBOROUGH, MA, 01752, US

(73) Assignee: ADVANCED MICRO DEVICES, INC., Sunnyvale, CA (US)

(21) Appl. No.: 12/793,719

(22) Filed: Jun. 4, 2010

Related U.S. Application Data
(60) Provisional application No. 61/184,501, filed on Jun. 5, 2009.

(51) Int. Cl. G06F 17/50; G06F 9/455

(52) U.S. Cl. 716/106

(57) ABSTRACT

Described are verification devices and methods for controlling X propagation in a circuit design which identify a first location in a circuit at which an X value is generated, specify a second location in the circuit at which the X value is unwanted, and prove that the X value is unable to propagate from the first location to the second location over any path through the circuit between the first and second locations.

### RELATED APPLICATION

This application claims priority to and the benefit of U.S. Provisional Patent Application No. 61/184,501, filed on Jun. 5, 2009, the contents of which are hereby incorporated by reference in their entirety.

### FIELD

The present inventive concepts relate generally to design verification systems and methods, and, more specifically, to formal property verification tools and techniques that enable X handling.

### BACKGROUND

As hardware circuits increase in complexity, it is important that integrated circuit designs are thoroughly tested for possible errors prior to fabrication. However, verifying a circuit design accurately and efficiently has become more difficult due to the ever-increasing number of transistors integrated on a single chip. As a result, chips are often produced that include design errors, or bugs, that were not discovered during design verification.

A typical approach to debugging circuit designs is to simulate the operation of the design at one or more levels of abstraction, for example, at the register transfer level (RTL) and gate level.

Conventional simulation approaches often include the use of unknown values, or Xs, in detecting errors. Xs are added to RTL code to allow for gate-level synthesis optimizations. However, designers tend to avoid using explicit X assignments in their RTL code because X's can cause inconsistencies between RTL and gate level simulations due to so-called X-optimistic behavior of simulators. Thus, an inaccurate simulation may occur when Xs are not propagated in a predictable manner. For example, X-optimism may occur, where real values, i.e., binary value of 0 or 1, are generated when the actual state is unknown. In another example, X-pessimism may occur, where X values are produced when the values could actually be known. Further, if an X propagates to an output at a first logic element, for example, resettable registers, then other logic elements along the propagation path may not process it correctly, leading to debugging problems, and causing large portions of the design under test (DUT) to become ‘unknown’. In addition, inaccurate simulation results may not match actual silicon behavior, potentially leading to failures in silicon.

Formal property verification tools have advantages by eliminating the need to write testbenches and tests, as required in simulation, and providing exhaustive mathematical proofs of design properties specified in a form of assertions. Consequently, simulation-based approaches can lead to incomplete results, thereby missing corner-case conditions where X propagation occurs. Conventional formal verification approaches treat Xs using 2-state hardware semantics (i.e., X=0; X=1) in order to address the above mentioned limitations. However, these approaches cannot handle X-propagation by applying all possible combinations of 0's and 1's to the primary inputs of the DUT. Therefore, the detection of X's in undesirable DUT locations, such as pointers to arrays, is not possible.

### SUMMARY

In one aspect, the inventive concepts feature a computer-executed method of controlling and verifying X propagation in a circuit design, the method comprising: identifying a first location in a circuit at which an X value is generated; specifying a second location in the circuit at which the X value is unwanted; and proving that the X value is unable to propagate from the first location to the second location over any path through the circuit between the first and second locations.

In another aspect, the inventive concepts feature a circuit design verification system comprising a computing device that executes computer readable instructions to identify a first location in a circuit at which an unknown value is generated and specify a second location in the circuit at which the unknown value is unwanted; and a verification tool that proves that the unknown value does not propagate from the first location to the second location over any path in the circuit.

In another aspect, the inventive concepts feature a computer program product for controlling and verifying X propagation in a circuit design, the computer program product comprising a computer-readable storage medium having computer-readable program code embodied therewith, the computer-readable program code comprising: computer-readable program code configured to identify a first location in a circuit at which an X value is generated; computer-readable program code configured to specify a second location in the circuit at which the X value is unwanted; and computer-readable program code configured to prove that the X value is unable to propagate from the first location to the second location over any path through the circuit between the first and second locations.

### BRIEF DESCRIPTION OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a flow diagram of an embodiment of a verification operation, in accordance with aspects of the present inventive concepts;

FIG. 2 is a flow diagram of an embodiment of a method of managing X propagation, in accordance with aspects of the present inventive concepts;

FIGS. 3A-3D are logic diagrams, each illustrating a logic combinational cloud generating an X value and a verification operation applied thereto, in accordance with aspects of the present inventive concepts; and

FIGS. 4A and 4B are data charts comparing formal verification analysis results between conventional formal tools and a verification system in accordance with aspects of the present inventive concepts.

### DETAILED DESCRIPTION

In order to overcome the limitations described above with regard to conventional approaches to verifying circuit designs, it is desirable that tools and techniques be provided that permit hardware design engineers to uncover bugs in a design or prove that bugs do not exist in the design by exploiting the benefits of unknown values, referred to as Xs, used in verifying circuit designs, while minimizing or eliminating limitations associated with the propagation of unknown values. Further, it is desirable that such tools and techniques provide comprehensive analysis and debugging features to validate desired X propagation through a circuit and ensuring that undesirable X propagation does not occur.

Formal property verification tools and techniques are often used for verifying the functional properties of a hardware design as a complementary approach to simulation. One benefit of formal verification is the ability to detect sources of X. For example, formal verification tools can be used to detect reachable X assignments, which can be present in RTL code for synthesis optimization purposes by assigning an X to a signal or wire. Reachable X-assignments can be reached or otherwise executed in simulation by applying a sequence of two-state vectors to the primary inputs of the circuit. Also, existing formal property verification tools can be used to detect uninitialized state-holding elements, such as flip-flops or registers, which when not reset or initialized can be regarded as sources of implicit X assignments.

However, the two-state approach (i.e., assigning a 0 or 1 to X) used in formal verification does not recognize X as an independent state, or “X state.” During RTL simulations, X can be propagated to an unwanted location at an output of a logic gate, such as an AND gate, or a flip-flop. During formal analysis, X is set to a 0 and/or 1 and there is no way to determine if a two-state value at the specific net within the synthesized netlist (formal tools operate on netlists synthesized from RTL code) is a result of a true two-state assignment or a reachable X-assignment.

In some approaches, engineers use assertions that check for undesired Xs. For example, coding guidelines can require that there should be an X default case for every case statement. Assertions can be provided to determine whether the default case is ever hit, or reached. Assertions can also be used to detect Xs on all important interfaces between blocks. However, it is difficult to develop simulation testbenches and tests that can cover exhaustively all possible X propagation scenarios, especially in complex circuit designs. Formal tools have to understand X-detection assertions and exhaustively verify that there is no sequence of two-state input vectors that can violate these assertions.

In addressing these shortcomings, embodiments of the present inventive concepts feature verification systems and methods that explore a design, consider and detect all possible X sources, and prove whether X propagation occurs at specified trap locations in the design, which are placed at locations in the circuit otherwise prohibited from receiving Xs. Thus, in the embodiments, the propagation of Xs through a circuit design can permit circuit designers to identify bugs in the design. For example, if a formal verification tool can generate a trace that shows in a waveform viewer how to propagate an X from its source to a specified trap, an RTL designer can decide to modify his RTL code in order to remove this uncertainty. If X cannot propagate to any specified trap locations, for example, when X is blocked by appropriate blocking conditions, all existing paths to the trap location, including any logic elements along the paths, should be verified.

In preferred embodiments, the design verification systems and methods can include the application and modification of formal verification techniques to provide improved control over X propagation while ensuring the safe use of X values, wherein such techniques can include enhancements that track Xs from their origin to either primary outputs or X_traps, ensuring unwanted X propagation. While embodiments herein describe enhanced formal verification techniques applied to RTL designs, these techniques can be applied architectural verification, protocol certification, design and IP leverage, low-power verification, SOC integration, and post-silicon debug applications.

The abovementioned can be achieved by first identifying first locations, also referred to as source locations, in a circuit at which Xs are generated, or locations along which propagating Xs are detected, then specifying second locations, also referred to as destinations of interest, which can be an output of a circuit or an internal signal within the circuit, at which Xs are unwanted. After the first and second locations are detected, the verification systems and methods in accordance with embodiments can prove that the unwanted Xs fail to propagate to the second locations. In particular, the verification systems and methods according to the present inventive concepts can detect undesired X propagation between the first and second locations by traversing all signal paths in the circuit design between any first and second location, and proving that there is no path between each location pair comprising a first location and corresponding second location, that delivers an X from the first location to the second location.

For example, the systems and methods in accordance with embodiments can prove that there is no combination of sequences of two state input vectors applied to circuit inputs so that an X propagates to the second location. In this example, X can be propagated from its origin through one or more circuit paths to a destination of interest where an X_trap is located to determine if the X propagates to the trap, or other observable output. If this occurs, for example, if combinations of sequences of two state input vectors are applied to the circuit inputs, then a counter-example can be generated, for example, a violation trace such as a value change dump (VCD) trace or waveforms, enabling the designer to observe the X-propagation details.

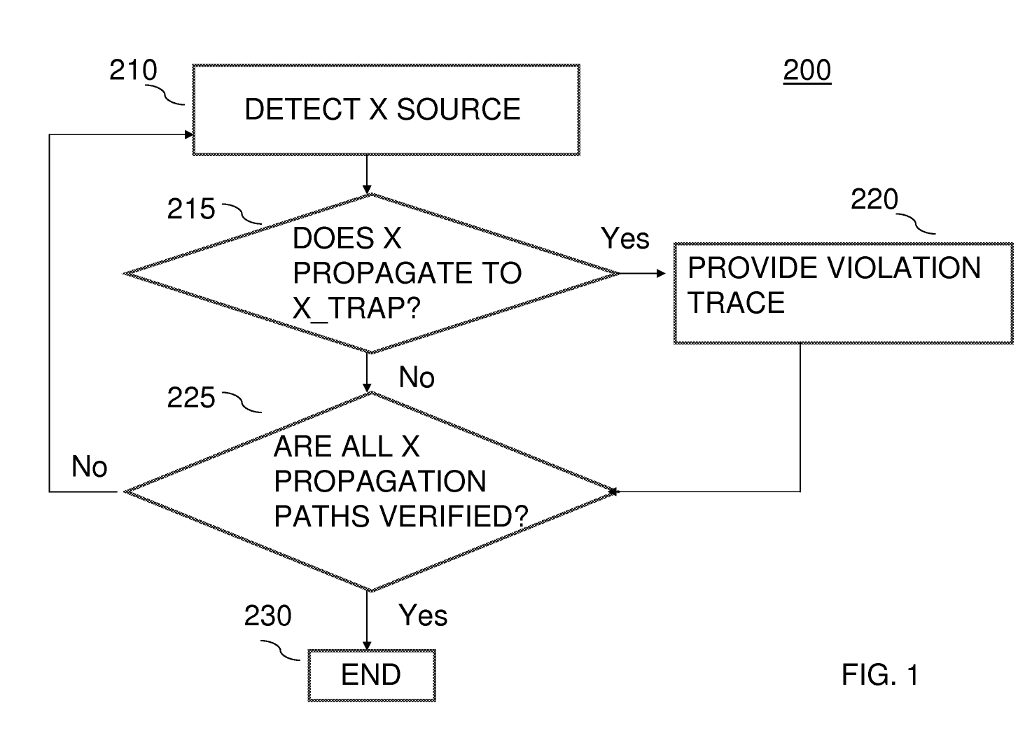

FIG. 1 is a flow diagram of an embodiment of a verification operation 200, in accordance with aspects of the present inventive concepts.

The verification operation 200 can be performed on a design under test (DUT), for example, an integrated circuit design, or other complex hardware design, such as an ASIC design or system-on-a-chip (SoC) design. In an embodiment, the verification operation 200 can be applied to a level of design in a design process, for example, RTL design.

In an embodiment, X values can be generated, which can propagate through a design during the verification operation 200, for verifying components of the design, the connections between the components, and the interactions they perform. In an embodiment, the X values can be produced by a value generator, for example, a random test program generator. However, in preferred embodiments, Xs are produced by other sources. In an embodiment, a source can be an explicit assignment, for example, a reachable X assignment. In another embodiment, primary inputs to a block take an X value under predefined constraints, referred to as a primary X-assignment. In another embodiment, an X-assignment occurs due to an unknown initial state, for example, an initial state of a non-resettable logic device, for example, a flip-flop, assigned to Xs. In another embodiment, X-assignments can occur as a result of X propagation. For example, X-generation can occur when a logic device receives an X from its inputs. Here, formal analysis can be performed on synthesized gate-level netlists, wherein these types of RTL X-assignments are not reachable in 2-state logic. As a result, X-propagation rules are used by a formal tool in order to run the X-verification formal analysis. X is implicitly assigned, for example, generated by an uninitialized register. The X values can be provided from other X sources known to those of ordinary skill in the art.

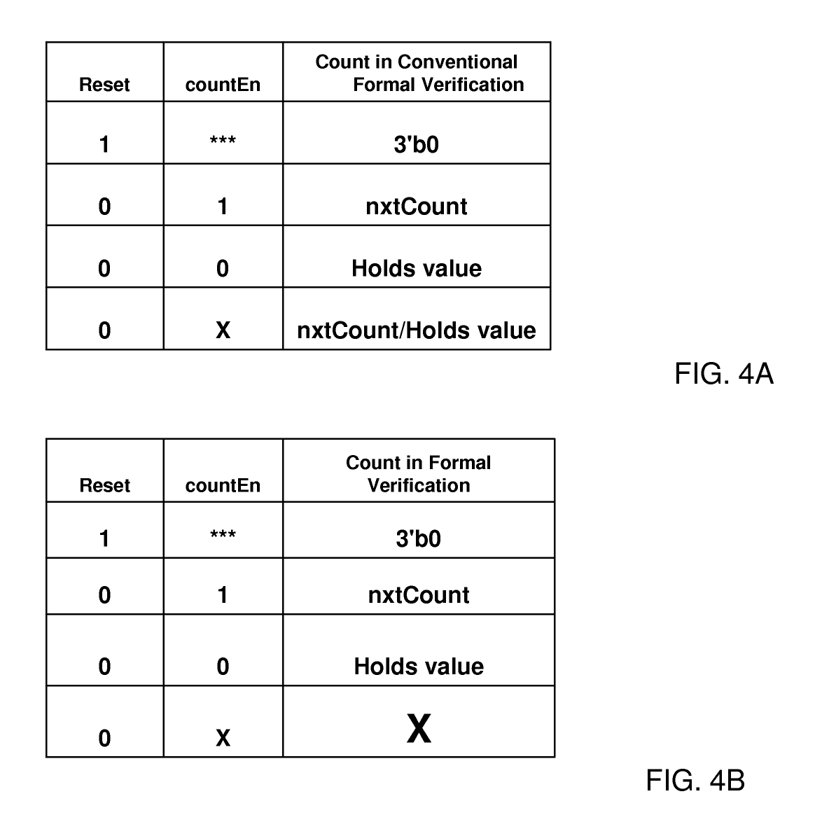

In an embodiment, X can be introduced to a design as a “third state.” Thus, instead of applying combinations of a ‘1’ and a ‘0’ for all Xs in accordance with conventional formal verification techniques, the present inventive concepts can apply combinations of a ‘1’, ‘0’, and ‘X’, where X is recognized as having a state, or sub-state, and wherein X can propagate having an X state through a circuit design, for example, shown in FIG. 4B. In addition, in accordance with embodiments described herein, while recognizing the dangers associated with the use of Xs in design verification, the risks associated with the use of Xs can be mitigated or eliminated since propagating Xs can be detected in the circuit design, thereby permitting the verification systems and methods to replace simulation in verifying chip designs.

As shown at step 210, one or more X sources are detected. In one embodiment, at least one reachable X assignment is detected. An X assignment can result from a combination of 1s and 0s applied to circuit inputs. In another embodiment, an X assignment can result from a combination of 1s and 0s applied to circuit inputs. In another embodiment, at least one unintended X assignment from a register, flip-flop, or other logic circuit, for example, an uninitialized register, is detected.

In embodiments where an X assignment is a reachable X-assignment, an X can propagate through a circuit path between two locations in a design, for example, a source and destination of an RTL design. In other embodiments, an X assignment may be an unreachable X assignment, for example, the design includes locations, for example, X_trap locations described herein, where X is intended to be blocked, tools and techniques described herein can prove that the X is an unreachable X assignment, and is blocked from propagating to an unwanted destination location in the circuit.

In an embodiment, formal tools known to those of ordinary skill in the art can be used to detect reachable X assignments. For example, scripts can be provided to perform a sequential comparison using commercial formal model checking tools. This comparison can compare two versions of the design by performing full model checking sequences to check for X differences in the outputs. Also, formal tools can apply constraints to design inputs to detect reachable X assignments. When performing the verification operation 200, Xs can be checked in each clock cycle.

In the verification operation 200, one or more X-generation (X_gen) locations can be identified, or a source in a design where X propagation originates. X_gen can be a signal within a block of code that is driven or assigned to an X. After the X source is detected, the X source can be analyzed by the designer to confirm that this was the designer's intent. Then, a formal verification analysis can be performed, for example, described below.

In the verification operation 200, one or more X_trap locations can be specified in the circuit design at which an X value is unwanted, or where a designer intends an X value to be trapped. The X_trap location can be a location where an X from an X_gen location is prevented from propagating. The X_trap location can be an assertion that protects a signal within RTL from receiving an X value.

In an embodiment, each X_gen location can have a corresponding X_trap location, electrically connected to each other via one or more signal paths, also referred to as circuit paths. If an unwanted X is detected at the X_trap location, then the verification system can determine whether a bug has occurred along any of the signal paths between the X_gen location and the X_trap location.

In some embodiments, techniques can be applied allowing the X_traps to be marked using an assertion language. In an embodiment, the X_trap locations can be specified using SystemVerilog Assertions (SVA), or more specifically, using constraints written as properties in SVA. In an embodiment, the SystemVerilog assertions can include a system function $isunknown ($isunknown (<expression>) returns true if any bit of the expression is X or Z, which is equivalent to: ̂<expression>==='bx); $isunknown can therefore be used to identify and trap Xs. In other embodiments, the X_trap locations can be specified as an assertion using but not limited to SystemVerilog or Verilog/VHDL, PSL, OVL, or any other assertion language, including any proprietary form of assertion languages. In another embodiment, the destinations of interest, i.e., X_trap locations, can be marked as formal tool specific pragmas in the form of comments. In an embodiment, an X_trap location is specified, or marked using an RTL pragmas, which can be used as a guide to generate a property or assertion to be proven by formal verification.

In an embodiment, every X_gen location in the design is paired with a corresponding X_trap location, wherein each X_gen-X_trap location pair includes at least one signal path therebetween. It is desirable that an X value does not propagate from a X_gen location of a given location pair to a corresponding X_trap location of the location pair via any circuit path between the X_gen location and the X_trap location, for example, by an X_block location on the one or more circuit paths between the X_gen and X_trap locations. If X propagates from the X_gen location to the X_trap location, then a trace can be provided for debugging purposes, as shown in step 220.

In an embodiment, formal tools can be applied to track all X_gen-X_{—}trap pairs, and ensure that there is no pair where an X_gen point does not have a corresponding reachable X_trap end point. For every source of generated Xs (X_gen) and every X_trap statement “no Xs are allowed on this wire,” the verification systems and methods described herein exhaustively verify that there is no possibility to have an X originating from any X_gen point that is later observed at any X_trap point, since there is no path between the X_gen and X_trap points that can delivers an X from the X_gen points to the X_trap points.

As shown in step 215, the verification system 100 can determine whether X propagates to an X_trap. This can be achieved by proving that for any pair of X_gen-X_trap locations, an X value generated at the X_gen location cannot propagate from the X_gen location to the X_trap location through any circuit path between the X_gen and X_trap locations.

In an embodiment, X values can be applied to all paths at the same time, and can detect conditions where Xs propagate to observable points.

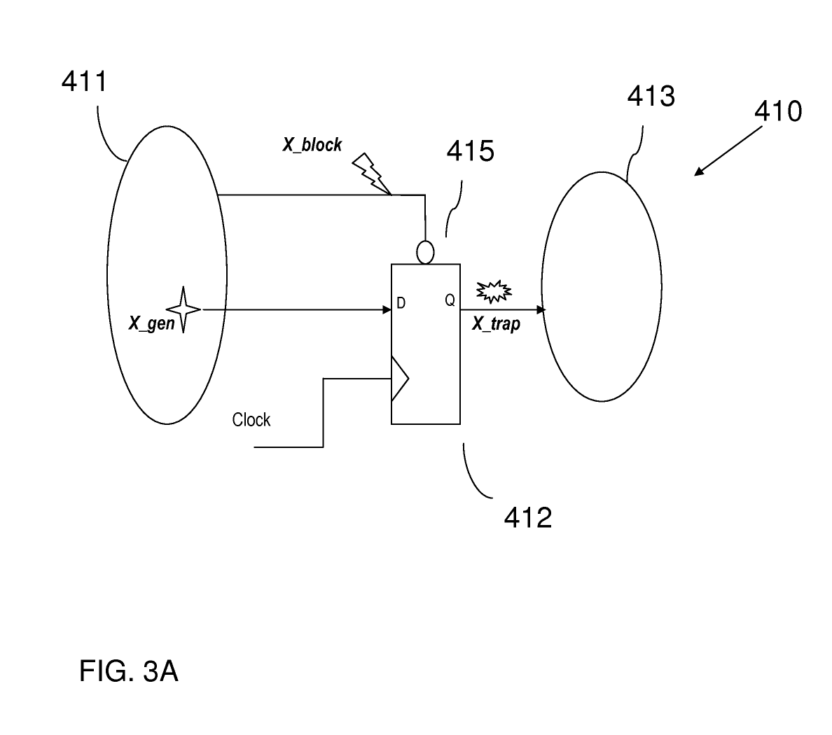

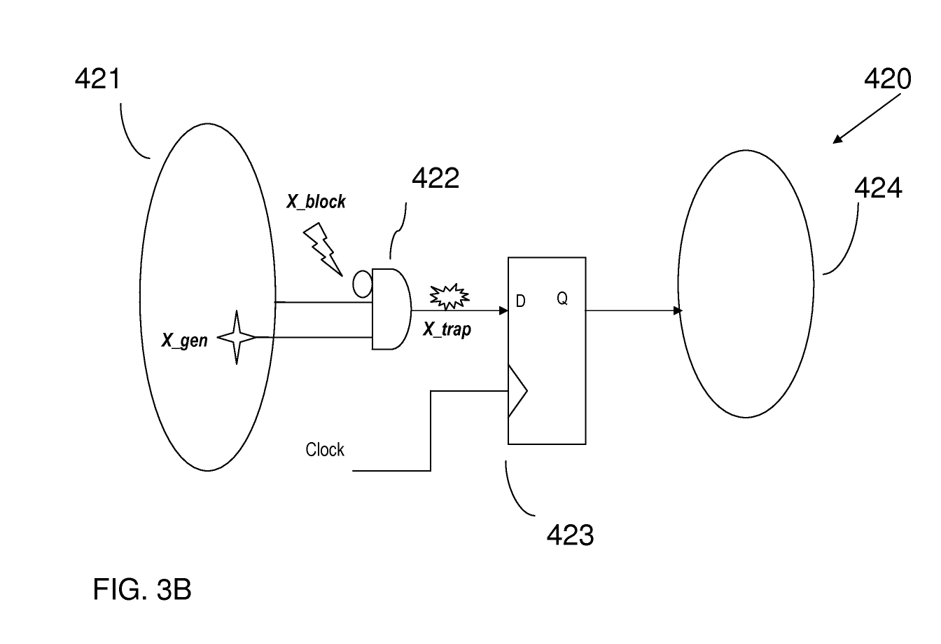

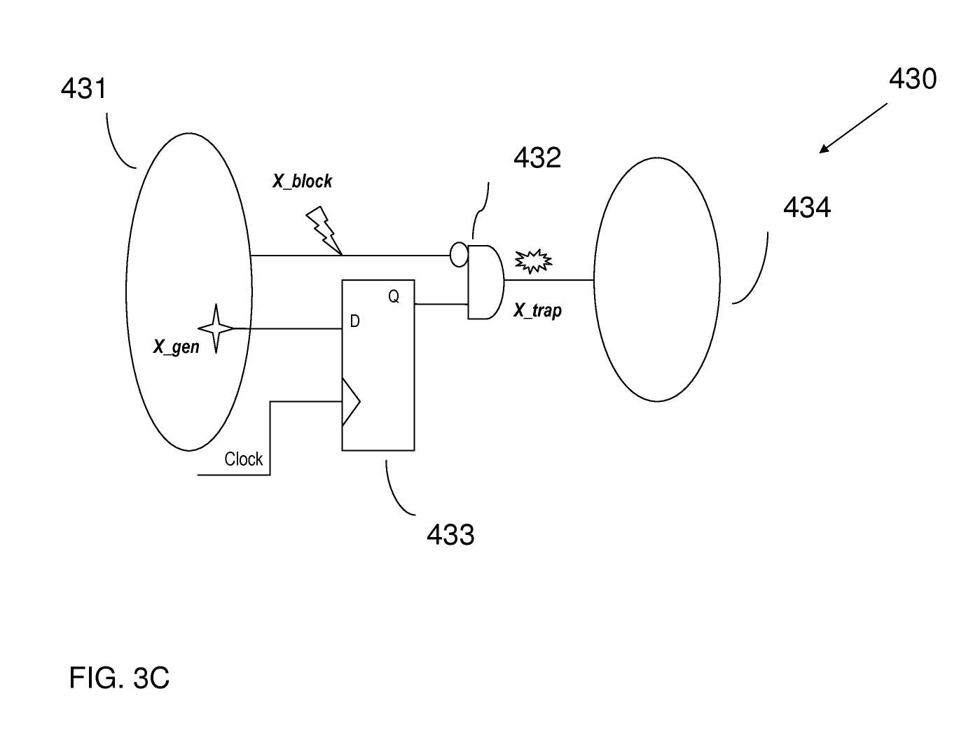

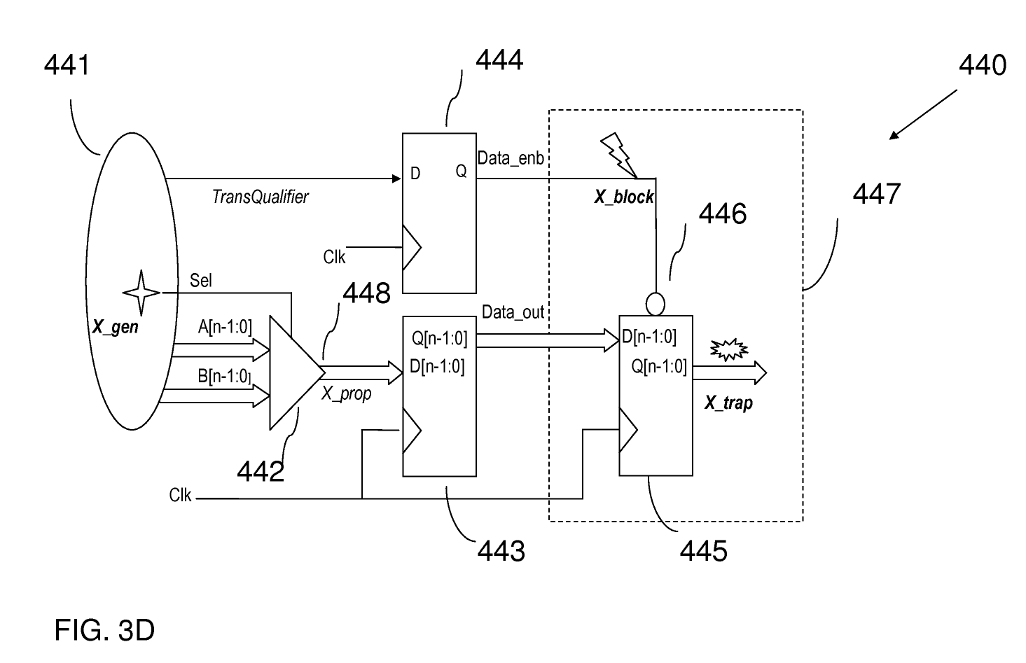

Accordingly, formal tools having X-propagation capabilities in accordance with embodiments of the present inventive concepts can formally or exhaustively prove that there is no combination of sequences of two-state input vectors that can be applied to the circuit inputs so that an X can be propagated from its X_gen source to its corresponding X_trap destination. For example, in a NAND gate implementation of a multiplexer, which can produce an X if the inputs are 01, 11, or 10, it can be proven that the X does not propagate from the multiplexer to an X_trap location on the output side of the multiplexer, for example, shown in FIG. 3D. If this input sequence exists, then a violation trace shown in step 220 can be produced where it is shown how an X can be observed at the X_trap destination.

For example, if a path is discovered by the verification system by which an X value can propagate to a given X_trap location, then a trace is generated. In an embodiment, X can be traced from its origin along a path to an output to ensure unwanted X propagation between the X origin and the unwanted location. If it is determined that X propagates to the unwanted location, then debugging tools, for example, debugging waveforms, can be applied to analyze the design and determine the cause of the unwanted X propagation. In an embodiment, the trace is a value change dump (VCD) trace. Accordingly, reachable X assignments can be proven by the verification system to be safe or unsafe. For example, designers can address the reachable X assignments by improving critical paths as necessary and only using X's that are proven to be unreachable.

In embodiments where the verification operation 200 is applied to complex circuit designs, design partitioning can be utilized, for example, applying auto-partitioning and/or block-by-block analysis.

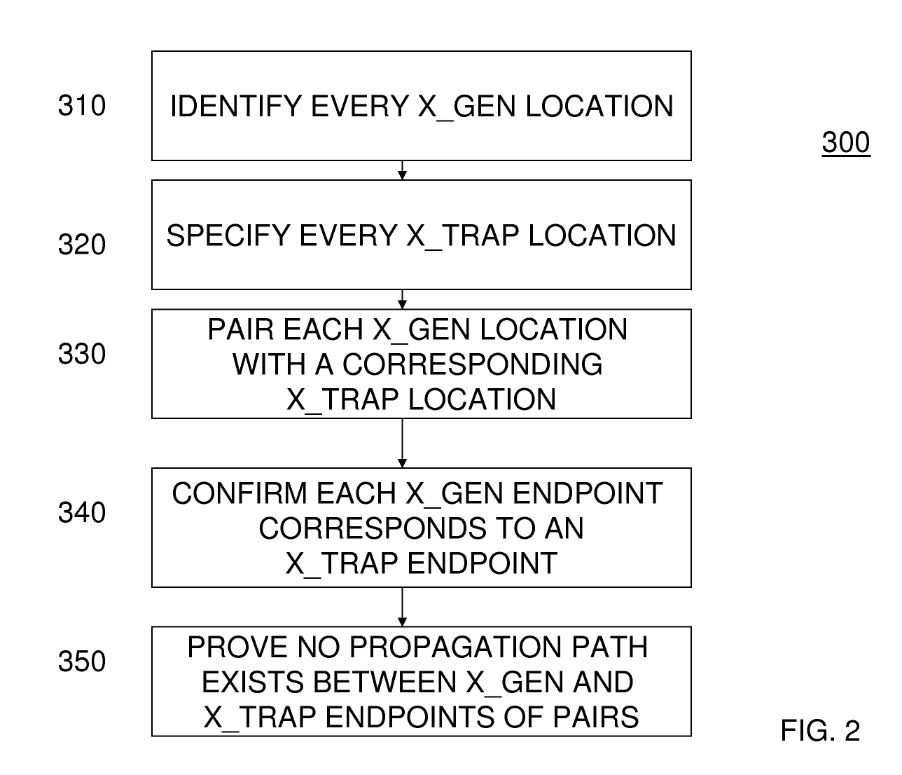

FIG. 2 is a flow diagram illustrating embodiments of a method 300 of managing X propagation, in accordance with aspects of the present inventive concepts.

In step 310, every X_gen location in a circuit design is identified. In an embodiment, a portion of the circuit design is identified by the circuit designer for verification, and all X_gen locations in the portion of the circuit design are approved by the designer as being available X sources. In other embodiments, a substantial portion or an entire circuit design is identified for verification, and all X_gen locations in the circuit design are approved by the designer as being acceptable X sources. In an embodiment, the X_gen locations are identified using formal verification tools and techniques, for example, described herein.

In step 320, every X_trap location in the circuit design is specified. The X_trap location can be a location where an X from an X_gen location is prevented from propagating.

In an embodiment, each X_gen location can have a corresponding X_trap location, electrically connected to each other via one or more signal paths, also referred to as circuit paths. If an unwanted X is detected at the X_trap location, then the verification system can determine whether a bug has occurred along any of the signal paths between the X_gen location and the X_trap location.

Formal tools generally require that all possible pair combinations between X_gen and X_trap are considered. Accordingly, in step 330, each X_gen location is paired with each X_trap location. In an embodiment, every X_gen location in the design is paired with a corresponding X_trap location, wherein each X_gen-X_trap location pair includes at least one signal path there between. It is desirable that an X value does not propagate from a X_gen location of a given location pair to a corresponding X_trap location of the location pair via any circuit path between the X_gen location and the X_trap location, for example, by an X_block location on the one or more circuit paths between the X_gen and X_trap locations.

In step 340, all X_gen-X_trap location pairs are tracked in order to confirm that all X_gen locations have a corresponding X_trap endpoint. In this manner, it can be determined whether any X_gen locations are missing that are not trapped. In an embodiment, formal tools and techniques can be applied to track all X_gen-X_trap location pairs and to ensure that each X_gen location has a corresponding X_trap location.

In step 350, tools and techniques described herein are applied to prove that no path exists between an X_gen location and a corresponding X_trap location in the location pairs along which an X can propagate and be observed at the X_trap location, for example, traces, waveforms, assertions, etc.

FIGS. 3A-3D are diagrams illustrating a logic combinational cloud and a verification operation applied thereto, in accordance with aspects of the present inventive concepts.

Generally, Xs in RTL code do not present any danger if they do not violate the functional and design intent of the logic, and the synthesized gate-level netlist is equivalent to the original RTL code behavior. If the RTL code is written properly, Xs are terminated or blocked within the logic so that it operates correctly. FIGS. 3A-3D illustrate techniques that can be used to verify that X values are terminated or blocked or otherwise prevented from propagating to downstream logic.

As shown in FIG. 3A, a logic section 411 of a combinational logic cloud 410 includes an X_gen location that generates an X value, which is blocked using clock gating. The logic section 411 also generates a logic 1 value for a clock gater input 415 of a flip-flop circuit 412 that blocks a clock signal (Clock). An X_block location is positioned at the clock gater input 415 of the flip-flop circuit 412. The X_block location can drive an X value, for example, 1'D0 on the clock gater input 415. An X_trap location is positioned at the output (Q) of the flip-flop circuit 412, which is a location where the designer does not want to generate an X.

The verification systems and methods described herein can be applied to the combinational logic cloud 410 to prove that the X value is blocked from being output from the flip-flop circuit 412, and therefore does not propagate from the X_gen location in the logic section 411 of the section to the X_trap location between the output of the flip-flop circuit 412 and logic 413 downstream from the flip-flop circuit 412.

FIG. 3B shows a logic section 421 of a combinational logic cloud 420 that generates an X value at an X_gen location, which is blocked by an AND gate 422. In particular, the X value is prevented from propagating from the X_gen location to an X_trap location by an X_block location positioned at a first input of an AND gate 422. In this example, the X value propagates to a second input of the AND gate 422, which blocks the X value from propagating to the D input of a flip-flop circuit 423. Here, the X_trap location is positioned at the input of the flip-flop circuit 423, which is a location where the designer does not want to receive an X, for example, logic elements 424 that are downstream from the flip-flop circuit 423.

The verification systems and methods described herein can be applied to the combinational logic cloud 420 to prove that the X value is blocked from being output from the AND gate 422, and therefore does not propagate from the X_gen location in the logic section 421 to the X_trap location at the output of the AND gate 422.

FIG. 3C shows a logic section 431 of a combinational logic cloud 430 that generates an X value at an X_gen location, which is blocked using an AND gate 432 coupled to an output of a flip-flop circuit 433. The X value propagates from the X_gen location to the input of the flip-flop circuit 433, and is output from the flip-flop circuit 433. However, The X value is blocked from further propagation by the AND gate 432 having an output at which is positioned an X_trap location, where the designer does not want receive an X, for example, logic elements 434 that are downstream from the flip-flop circuit 433.

The verification systems and methods described herein can be applied to the combinational logic cloud 430 to prove that the X value is blocked from being input to the AND gate 432 via the flip-flop circuit 433, and therefore does not propagate from the X_gen location in the logic section 431 of the section to the X_trap location at the output of the AND gate 432.

FIG. 3D shows a logic section 441 of a combinational logic cloud 440 that generates an X value at an X_gen location to a select line (Sel) of a multiplexer 442. The X value propagates to the select line (Sel) at the input of the multiplexer 442 and forces the multiplexer 442 to drive Xs on its outputs (X_prop). The data on the multiplexer output 448 is qualified by a control signal generated in parallel by the logic section 441 via a TransQualifier line. A first flip-flop 444 is coupled between the TransQualifier line and a receiving unit 447. A second flip-flop 443 is coupled between the multiplexer 442 and the receiving unit 447. The receiving unit 447 prevents reading the data from a bus (data_out) of the second flip-flop 443 by gating a third flip-flop 445 of the receiving unit 447 in response to a signal (data_enb) received by a clock gater 446 of the third flip-flop 445.

The verification systems and methods described herein can be applied to the combinational logic cloud 440 to prove that the X value is blocked by the third flip-flop 445 of the receiving unit 447, and therefore does not propagate to the X_trap location at the output of the third flip-flop 445.

FIGS. 4A and 4B are data charts comparing formal verification analysis results between conventional formal tools and a verification system in accordance with aspects of the present inventive concepts.

As shown in FIG. 4A, conventional formal tools will try both 0 and 1 values of countenable (countEn). When countEn is low (0), a corresponding clock-gating register, for example, flip-flop 412 shown in FIG. 3A, does not clock (i.e., Reset=0) and, under formal verification, holds the current value. However, when a don't care X is assigned to countEn, for example, to minimize driving logic, conventional formal verification considers both possible settings of the X assignment (X=1, nxtCount; X=0, Holds value); specifically, conventional formal verification tries both 0 and 1 values of countEn. However, in this two-state approach, i.e., assigning a 0 or 1 to X, X is not recognized as having an independent state, i.e., an X state, and can therefore not be easily detected at locations along the propagation path.

As shown in FIG. 4B, enhanced formal verification can address this problem by propagating X having an X state through the circuit design when an X is assigned to countEn. Specifically, instead of trying both possible values of X (i.e., 1 and 0), X is recognized as having its own state, or X state. In this manner, enhanced formal verification as shown in FIG. 4B can permit Xs to be output having an X state, therefore allowing Xs to be detected in undesirable locations. Accordingly, all propagation paths between the source location of X and the undesirable locations can be verified.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the invention has been shown and described with reference to specific preferred embodiments, it should be understood by those skilled in the art that various changes in form and detail may be made therein without departing from the spirit and scope of the invention as defined by the following claims.

What is claimed is:

1. A computer-executed method of controlling and verifying X propagation in a circuit design, comprising:
identifying a first location in a circuit at which an X value is generated;
specifying a second location in the circuit at which the X value is unwanted; and
proving that the X value is unable to propagate from the first location to the second location over any path through the circuit between the first and second locations.

2. The computer-executed method of claim 1, wherein the circuit design is described using any HDL (hardware description language) at the RTL level.

3. The computer-executed method of claim 1, wherein formal analysis techniques are applied to prove that the X value is unable to propagate from the first location to the second location over any path through the circuit between the first and second locations.

4. The computer-executed method of claim 1, wherein the second location is a trap location at which the X value is unwanted.

5. The computer-executed method of claim 4, wherein a violation trace is generated if the X value propagates to the trap location.

6. The computer-executed method of claim 5, wherein the violation trace includes a VCD (value change dump) trace.

7. The computer-executed method of claim 1, wherein the second location is specified as an assertion using SystemVerilog or Verilog/VHDL, PSL, OVL, or a proprietary form of assertion languages.

8. The computer-executed method of claim 1, wherein the second location is specified using an RTL pragma that can be used as a guide to generate a property to be proven by formal verification.

9. The computer-executed method of claim 1, wherein said method is performed in response to performing computer readable instructions stored on a computer-readable storage medium.

10. The computer-executed method of claim 1, wherein the first location comprises at least one X_gen location and the second location includes at least one X_trap location.

11. The computer-executed method of claim 10 further comprising:
identifying every X_gen location in a circuit design at which an X value is generated;
specifying every X_trap location in the circuit design at which an X value is unwanted;
pairing each X_gen location at which an X value is generated with each X_trap location at which an X value is unwanted; and
proving through formal verification that for each pair of X_gen-X_trap locations that the X value generated at the X_gen location of that X_gen-X_trap location pair cannot propagate from that X_gen location to the X_trap location of that X_gen-X_trap location pair.

12. A circuit design verification system comprising:
a computing device that executes computer readable instructions to identify a first location in a circuit at which an unknown value is generated and specify a second location in the circuit at which the unknown value is unwanted; and
a verification tool that proves that the unknown value does not propagate from the first location to the second location over any path in the circuit.

13. The verification system of claim 12, wherein the first location is an X_gen location and the second location is an X_trap location.

14. The verification system of claim 13, wherein the computing device executes computer readable instructions to identify every X_gen location in the circuit at which an unknown value is generated and every X_trap location in the circuit at which an unknown value is unwanted and to pair each X_gen location at which the unknown value is generated with each X_trap location at which the X value is unwanted.

15. The verification system of claim 14, wherein the verification tool proves for each pair of X_gen-X_trap locations that an X value generated at a X_gen location of a X_gen-X_trap location pair cannot propagate to a corresponding X_trap location of the X_gen-X_trap location pair.

16. The verification system of claim 14, wherein the verification tool applies formal verification.

17. A computer program product for controlling and verifying X propagation in a circuit design, the computer program product comprising:
a computer-readable storage medium having computer-readable program code embodied therewith, the computer-readable program code comprising:
computer-readable program code configured to identify a first location in a circuit at which an X value is generated;
computer-readable program code configured to specify a second location in the circuit at which the X value is unwanted; and
computer-readable program code configured to prove that the X value is unable to propagate from the first location to the second location over any path through the circuit between the first and second locations.

18. The computer program product of claim 17, wherein the computer-readable program code comprises hardware description language instructions.

19. The computer program product of claim 17 further comprising computer-readable program code configured to specify the second location as an assertion using an assertion language.

20. The computer program product of claim 17 further comprising computer-readable program code configured to specify the second location using an RTL pragma.
